(19) United States
(12) Patent Application Publication
(10) Pub. No.: US 2011/0202168 A1
(43) Pub. Date: Aug. 18, 2011

(54) Welding-Type System With Embedded Database

(75) Inventors: Bruce A. Casner, Neenah, WI (US); L. Thomas Hayes, Oshkosh, WI (US)

(73) Assignee: Illinois Tool Works Inc., Glenview, IL (US)

(21) Appl. No.: 12/965,171

(22) Filed: Dec. 10, 2010

Related U.S. Application Data
(60) Provisional application No. 61/303,729, filed on Feb. 12, 2010.

(51) Int. Cl. G06F 19/00

(52) U.S. Cl. 700/207

(57) ABSTRACT

A method and apparatus for providing welding-type power is disclosed and includes a database, preferably with a DBMS, and preferably embedded. The welding-type system includes a source of power, and a controller connected to the source of power. The DBMS may be part of the welding controller. A method of monitoring a welding-type system is also disclosed, and includes monitoring data and storing the data in an embedded database. The database may include data organized in a plurality of columns and rows, and the date may relate to one or more welding processes, data relating to welding parameters, including one or more of commanded welding voltages, welding current, wire feed speed, data relating to one or more welding sequences, and/or one or more fedback welding parameters such as current, voltage, welding time, ramp rates and wire feed speed. The data may be located in a file in an operating system, in a file on a personal computer, and/or in a file networked to the welding-type system. The system may include a user input connected to the database and the user can change the data in another embodiment. The user input may be connected to a network.

### FIELD OF THE INVENTION

The present invention relates generally to the art of welding-type power supplies. More specifically, it relates to a welding-type power supply with a database management system (DBMS) and/or an embedded database.

### BACKGROUND OF THE INVENTION

There are many known welding-type systems used to provide a welding-type output or welding-type power for many known applications. Welding-type system, as used herein, includes any device capable of supplying welding, plasma cutting, and/or induction heating power including converters, inverters, choppers, resonant power supplies, quasi-resonant power supplies, etc., as well as control circuitry and other ancillary circuitry associated therewith. Welding-type output, as used herein, includes outputs suitable for welding, plasma or heating. Welding type power, as used herein, refers to welding, plasma or heating power.

Examples of prior art welding-type systems include those described in Method of Designing and Manufacturing Welding-Type Power Supplies, Albrecht, filed Sep. 19, 2001, application Ser. No. 09/956,401, which issued on Mar. 30, 2004 as U.S. Pat. No. 6,713,721; Pendant Control for a Welding-Type System, L. Thomas Hayes, filed Sep. 19, 2001, application Ser. No. 09/956,502, which issued on Oct. 28, 2003 as U.S. Pat. No. 6,639,182; Welding-Type Power Supply With A State-Based Controller, Holverson et al, filed Sep. 19, 2001, application Ser. No. 09/956,548, which issued on Jun. 8, 2004 as U.S. Pat. No. 6,747,247; Welding-Type System With Network And Multiple Level Messaging Between Components, Davidson et al., filed Sep. 19, 2001, application Ser. No. 09/957,707, which issued on Dec. 30, 2003 as U.S. Pat. No. 6,670,579; Welding-Type Power Supply With Boot Loader, L. Thomas Hayes, filed Sep. 19, 2001, application Ser. No. 09/956,405, which issued on Jan. 7, 2003 as U.S. Pat. No. 6,504,131; and Welding-Type System With Robot Calibration, Rappl et al., filed Sep. 19, 2001, application Ser. No. 09/956,501, which issued on Nov. 4, 2003 as U.S. Pat. No. 6,642,482. Each of these patents is hereby incorporated by reference.

Some such systems, particularly, microprocessor controlled welding-type system store numerous variables that are used to perform the weld. For example, whether Preflow is needed for a weld and if so, how long is the preflow period. Examples of other stored variables includes the process (MIG, pulse, Accupulse®, etc.), the voltages, currents, and wire feed speeds used for the process, the sequences of the weld (Arc Start, Start Power, Weld, Crater, etc.), special trigger functions such as dual schedule, trigger dual schedule, trigger program select, 4T operation, and trigger hold, and durations of each. There are also many variables saved relating to productivity records (inches of wire used, number of arc starts, amount of time spent welding, etc). These and other variables are stored and used to control the weld and sequencer, and to keep track of welder productivity.

In some prior art systems only the weld controller and simple user interface accessed these variables, and it was sufficient that they be stored in memory as unrelated information, with no organization or structure. However as these variables are accessed by other entities, such as over a network, other users, data loggers, productivity analyzers, etc, simply storing the variables in memory becomes problematic. Accordingly, a welding-type system that includes an effective way to store multiple variables, and to allow access to those variable from multiple sources, is desirable.

### SUMMARY OF THE PRESENT INVENTION

According to a first aspect of the invention a welding-type system includes a source of power, and a controller connected to the source of power. The controller includes an embedded database.

According to a second aspect of the invention a method of controlling a welding-type system includes storing data in an embedded database and accessing the stored data using a welding controller. The output of a welding-type power source is controlled in response to the data accessed.

According to a third aspect of the invention a method of monitoring a welding-type system includes monitoring data and storing the data in an embedded database.

According to a fourth aspect of the invention an embedded database for a welding-type system is provided.

The database includes data organized in a plurality of columns and rows in one embodiment.

The data is stored variables used to perform the weld, data relating to one or more welding processes, data relating to welding parameters, including one or more of commanded welding voltages, welding current, wire feed speed, data relating to one or more welding sequences, and/or one or more fedback welding parameters such as current, voltage, welding time, ramp rates and wire feed speed in various embodiments.

The database provides for queries from multiple users in one embodiment.

The data cannot be accessed in an intermediate state in another embodiment.

The data is located in a file in an operating system, in a file on a personal computer, and/or in a file networked to the welding-type system in various embodiments.

The system includes a user input connected to the database and the user can change the data in another embodiment. The user input may be connected to a network.

Other principal features and advantages of the invention will become apparent to those skilled in the art upon review of the following drawings, the detailed description and the appended claims.

### BRIEF DESCRIPTION OF THE DRAWINGS

FIG. 1 is a welding-type system in accordance with the preferred embodiment of the present invention; and

FIG. 2 is block diagram in accordance with the preferred embodiment of the present invention.

Before explaining at least one embodiment of the invention in detail it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting. Like reference numerals are used to indicate like components.

### DETAILED DESCRIPTION OF THE PREFERRED EMBODIMENTS

While the present invention will be illustrated with reference to a particular welding-type system it should be understood at the outset that the DBMS can be used with other welding-type systems.

The preferred embodiment provides for implementing the invention with the Miller Axcess® or Miller Axcess E® welding power supply. The welding-type system includes a control module with an embedded database. Module, as used herein, includes software and/or hardware that cooperates to perform one or more tasks, and can include digital commands, control circuitry, power circuitry, networking hardware, etc.

A database is a structured collection of records or data that is stored in a digital system. A database preferably is able to store large amounts of records and be accessed easily. In addition, new information and changes should also be fairly easy to input. An efficient database system often incorporates a program that manages the queries and information stored on the system. This is referred to as DBMS or a database management system.

DBMSs are designed to provide the ability to store, manage and retrieve information through the use of tables. Tables are made up of columns and rows. Each column contains a different attribute, whereas each row represents a single record. This allows data to be organized and stored in meaningful ways.

An embedded database system is a database management system (DBMS) which is tightly integrated with an application software that requires access. The embedded database is preferably either available commercially, or compatible therewith, to make it easier for the programmer, designer, and/or user to learn and use the database. The welding-type system can include an OS, particularly an off the shelf operating system. Alternatives include using a custom DBMS, and using a DBMS that is not embedded, and/or resides outside the weld controller, such as on a PC in the weld cell or networked to the weld cell. The DMBS is still considered part of the welding system controller, as controller is used herein, when the DMBS is located on a PC or remotely on a network.

As explained above, some microprocessor controlled weld controller have numerous stored variables used to perform the weld. Having an embedded database to organize these variables into tables allows users to access them in a more structured manner. Also, the program that manages the database queries allows access by multiple users and helps insure that either all of the tasks of a transaction (such as a weld cycle) are performed or none of them are.

Using a DBMS and/or an embedded database helps insure that other operations by another user cannot access or see the data in an intermediate state during a transaction. (Intermediate state refers to data that is in the process of being modified). This can be more important as additional users access these variables, and the probability that two users will be trying to change the same variable at the same time increases. Database programs are designed to handle multiple users and guarantee that transactions will be handled completely and independently from the previous/next transaction

The DBMS, because of it's flexibility, allows each user to execute specific queries returning only the specific data that the user needs as defined by the query. While a table may contain many columns, if the user does not need all of them they will not be bothered with the extra data. DBMSs are also designed to handle large amounts of data.

Moreover, when an application exits or fails, all information remains stored in the database. Since the database is a file within the OS if there is a hardware failure the data within the database can usually be recovered.

Some weld cells require the use of a pc (personal computer). If there is a pc within the cell the DBMS could reside on the pc instead of being embedded. Also, if the weld cell is networked, the DBMS could reside on the network.

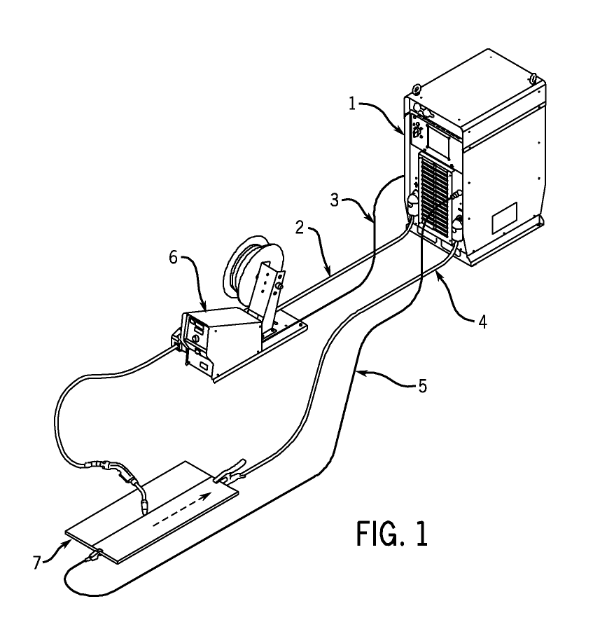

Referring to FIG. 1, a welding-type system 100 includes a power supply 1, and a wire feeder 6, which cooperate to provide power over a pair of weld cables 2 and 4 to a workpiece 7. Feeder cable 3 and a voltage sense cable 5 are used for control/feedback. The system shown is an Axcess® welding system, but the invention may readily be implemented with other welding-type systems.

Welding system 100 performs generally as prior art welding systems, but includes an embedded database. Preferably, the database stores and allows access to one or more of the process being used (MIG, pulse, Accupulse®, etc.), the voltages, currents, and wire feed speeds used for the process, the sequences of the weld (Arc Start, Start Power, Weld, Crater, etc.), special trigger functions such as dual schedule, trigger dual schedule, trigger program select, 4T operation, and trigger hold, and durations of each, as well as other variables known in such welding operations. Data that is stored in the database may include commanded or fedback welding data such as welding current, voltage, welding time, ramp rates, wire feed speed, etc, as well as errors, faults, alerts, etc.

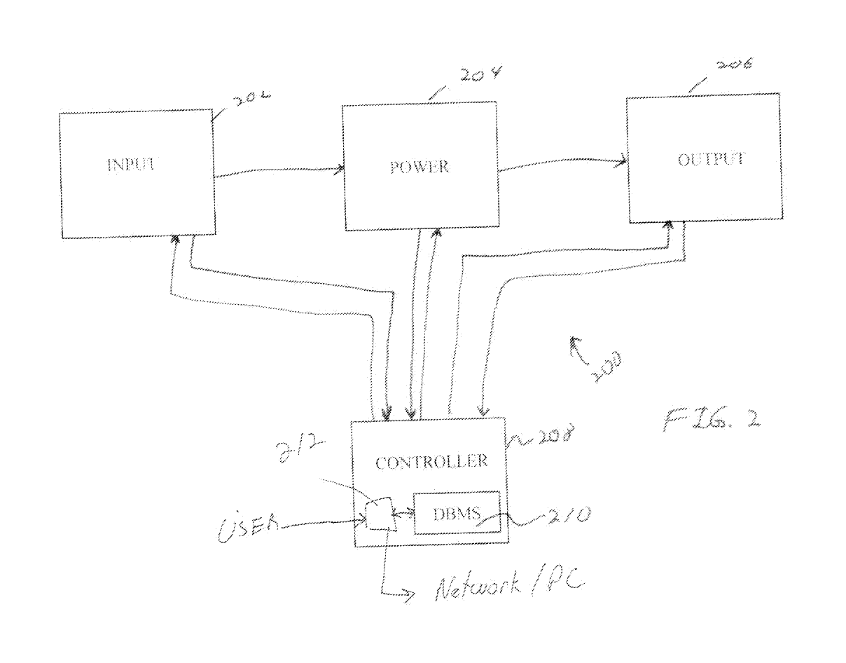

Referring now to FIG. 2, a diagram shows a welding-type system 200 includes an input circuit 202, a power circuit 204, and an output 206, as well as a controller 208. Circuits 202, 204 and 206, and controller 208, are part of welding power supply 1 (FIG. 1) in the preferred embodiment. They are distributed over several locations (such as wire feeder 6, an external control circuit, etc.) in other embodiments. Circuits 202, 204 and 206, and controller 208 are functional blocks and need not be physically distinct circuits.

Circuits 202, 204 and 206, are, in one embodiment, consistent with those shown in U.S. Pat. No. 6,329,636, entitled Method And Apparatus For Receiving A Universal Input Voltage In A Welding, Plasma Or Heating Power Source, issued Dec. 11, 2001, which is hereby incorporated by reference. Accordingly, circuits 202, 204 and 206 may include circuitry to rectify, boost, power factor correct, invert and transform different input powers into welding-type power.

Controller 208 includes much of the control circuitry of the prior art, including that used to turn switches on and off circuits 202, 204 and 206. This switch control circuitry can be implemented with other control circuitry, including digital, analog, and include micro processors, DSPs, analog circuitry, etc. Also, controller 208 preferably includes circuitry to monitor and/or log operating date.

In accordance with the invention a database module 210 includes a DBMS, and is preferably embedded into welding-type system 200. Other embodiments provide that the database not be embedded, and/or be located outside of controller 208, in the weld cell, or on a network connected to the weld cell.

In operation module 210 stores the variable listed above (and can store only some of them, or additional variables in other embodiments). When controller 208 needs to access the variable, it does so using module 210. Also, module 210 allows the user, designer or engineer to change the variables if needed using a user input 212, locally or remotely, as described below.

Various alternatives provide that welding-type system 100 includes network communication, such as WAN, LAN, over power lines, over a smart grid, and that the data transmitted and/or stored, such as on a USB drive, include arc parameters and primary information, such as harmonics data, utilization data, etc. The information can be stored in the database, and it or other information in or not in the database can be shared over the network or using a drive with end users, power companies, manufacturers that use welders, manufactures that supply welders, etc. Additionally, various alternatives and arrangements are shown in the attached appendix.

Numerous modifications may be made to the present invention which still fall within the intended scope hereof. Thus, it should be apparent that there has been provided in accordance with the present invention a method and apparatus for a welding-type system with a database, preferably with a DBMS, and more preferably an embedded that fully satisfies the objectives and advantages set forth above. Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

The embodiments of the invention in which an exclusive property or privilege is claimed are defined as follows:

1. A welding-type system including a source of power, and a controller connected to the source of power, wherein the controller includes an embedded database.

2. The welding-type system of claim 1, wherein the database includes data organized in a plurality of columns and rows.

3. The welding-type system of claim 1, wherein the database includes as data stored variables used to perform the weld.

4. The welding-type system of claim 2, wherein the database provides for queries from multiple users.

5. The welding-type system of claim 3, wherein the data cannot be accessed in an intermediate state.

6. The welding-type system of claim 1, wherein the database includes data located in a file in an operating system.

7. The welding-type system of claim 6, wherein the data is located in a file on a personal computer.

8. The welding-type system of claim 6, wherein the data is located in a file networked to the welding-type system.

9. The welding-type system of claim 1, wherein the embedded database includes data relating to more than one welding process.

10. The welding-type system of claim 1, wherein the embedded database include data relating to welding parameters, including one or more of commanded welding voltages, welding current, wire feed speed.

11. The welding-type system of claim 1, wherein the embedded database include data relating to one or more welding sequences.

12. The welding-type system of claim 1, wherein the database includes data related to one or more fedback welding parameters of current, voltage, welding time, ramp rates and wire feed speed.

13. The welding-type system of claim 2, including a user input connected to the database, wherein the user can change the data.

14. The welding-type system of claim 13, wherein the user input is further connected to a network.

15. A method of controlling a welding-type system, comprising:
storing data in an embedded database;
accessing the stored data using a welding controller; and
controlling the output of a welding-type power source in response to the data accessed.

16. The method of claim 15, wherein storing includes storing data in a file in an operating system.

17. The method of claim 15, wherein storing includes storing data in a file located on a personal computer.

18. The method of claim 15, wherein storing includes storing data in a file located on network connected to the welding type system.

19. The method of claim 15, wherein accessing includes accessing data in a file located on network connected to the welding type system.

20. The method of claim 15, wherein:
storing data includes storing data relating to more than one welding parameter;
accessing includes accessing data for at least a selected one welding parameter.

21. The method of claim 15, wherein:
storing data includes storing data relating to more than one welding process;
accessing includes accessing data for a selected one welding process; and
controlling includes controlling the output to be the selected welding process.

22. The method of claim 15, wherein:
storing data includes storing data relating to more than one welding sequence;
accessing includes accessing data for at least one selected welding sequences; and
controlling includes controlling the output to provide the at least one selected welding sequence.

23. The method of claim 15, including receiving a user input and changing the data in response to the user input.

24. The method of claim 15, including receiving a user input over network and changing the data in response to the user input.

25. A method of monitoring a welding-type system, comprising monitoring data and storing the data in an embedded database.

26. The method of claim 25, wherein monitoring data includes monitoring at least one of commanded or fedback data.

27. An embedded database for a welding-type system.

28. The database of claim 27, wherein the database includes as data stored variables used to perform the weld.

29. The database system of claim 28, wherein the data is located in a file networked to a welding-type system.

30. The database of claim 29, wherein the embedded database include data relating to one or more one welding processes, one or more of commanded welding voltages, welding current, wire feed speed, and one or more welding sequences.
